(19) United States
(12) Patent Application Publication
(10) Pub. No.: US 2009/0121164 A1
(43) Pub. Date: May 14, 2009

(54) ENHANCED OPTICAL MULTI-FEED DETECTION

(76) Inventors: Joseph M. Gagnier, Birmingham, MI (US); Paul J. McCarthy, Commerce, MI (US)

Correspondence Address: UNISYS CORPORATION, UNISYS WAY, MAIL STATION: E8-114, BLUE BELL, PA, 19424, US

(21) Appl. No.: 12/036,332

(22) Filed: Feb. 25, 2008

Related U.S. Application Data
(60) Provisional application No. 61/002,826, filed on Nov. 13, 2007.

(51) Int. Cl. G01N 21/86

(52) U.S. Cl. 250/559.15

(57) ABSTRACT

A multiple document feed detection system, such as for use in an automatic document processing system, is disclosed. The multiple document feed detection system includes a plurality of light sources oriented to direct light across a path of travel of documents. The system also includes a plurality of photodetectors placed adjacent to the path of travel, with each photodetector placed on an opposite side of the path of travel from a corresponding light source and oriented toward the corresponding light source. The plurality of photodetectors is configured to detect transmissivity of light emitted from the light sources through documents passing through the path of travel. The system further includes a signal detection and voting module interconnected with the light sources and the phototransistors, the signal detection and voting module configured to detect the presence of the overlapping documents passing through the path of travel.

### CROSS REFERENCE TO RELATED APPLICATIONS

The present application claims priority to U.S. Provisional Patent Application No. 61/002826, dated Nov. 13, 2007, the disclosure of which is hereby incorporated by reference in its entirety.

### TECHNICAL FIELD

The present disclosure relates to systems for detecting overlapping documents fed into a document processing system. In particular, the present disclosure relates to an optical multi-feed detection system.

### BACKGROUND

Automated document processing systems generally are configured to process a large number of documents without requiring user interaction. These automatic document feed systems are prone to multiple feeds (more than one document feeding at a time) as feeder components wear or become out of adjustment. Multiple feeds may be very costly as undetected documents (e.g. checks) are lost from the document processing workflow, such as when two documents at least partially overlap.

Various solutions to the problem of multiple document feeds have been implemented. For example, systems exist which utilize a vacuum, acoustic and friction alternate mechanisms to separate documents received at a document feeder. These systems are generally expensive, and can be unreliable due to the existence/wear of mechanical components.

An existing approach to detecting multiple feeds is to use opto-electronic devices (i.e. a LED—phototransistor pair) to look for variation in the optical transmission properties of documents as they exit the document feeder to detect indications of a suspected multi-feed error. However, even with such existing systems, variations in paper thickness can result in false positive detections of overlapping documents, or can result in not detecting such overlapping documents.

For these and other reasons, improvements are desirable.

### SUMMARY

In accordance with the present disclosure, the above and other problems are addressed by the following:

In a first aspect, a multiple document feed detection system is disclosed. The multiple document feed detection system includes a plurality of light sources oriented to direct light across a path of travel of documents. The system also includes a plurality of photodetectors placed adjacent to the path of travel, with each photodetector placed on an opposite side of the path of travel from a corresponding light source and oriented toward the corresponding light source. The plurality of photodetectors are configured to detect transmissivity of light emitted from the light sources through documents passing through the path of travel. The system further includes a signal detection and voting module interconnected with the light sources and the phototransistors, the signal detection and voting module configured to detect the presence of the overlapping documents passing through the path of travel.

In a second aspect, an automated document processing system is disclosed. The automated document processing system includes a document feeder arranged to serially feed documents into a path of travel. The system also includes a plurality of light sources oriented to direct light across the path of travel. The system further includes a plurality of photodetectors placed adjacent to the path of travel. Each photodetector is placed on an opposite side of the path of travel from a corresponding light source and oriented toward the corresponding light source. The plurality of photodetectors are configured to detect transmissivity of light emitted from the light sources through documents passing through the path of travel. The system also includes a signal detection and voting module interconnected with the light sources and the phototransistors, the signal detection and voting module configured to detect the presence of the overlapping documents passing through the path of travel.

In a third aspect, a method of detecting multiple document feeds in an automated document processing system is disclosed. The method includes transmitting light from a plurality of light sources across a path of travel of documents. The method also includes receiving at least a portion of the light at a plurality of photodetectors, each photodetector located on the opposing side of the path of travel of documents from a corresponding light source from the plurality of light sources. The method further includes detecting the presence of overlapping documents passing along the path of travel based on the portion of the light received at the plurality of photodetectors.

### BRIEF DESCRIPTION OF THE DRAWINGS

FIG. 1 is a schematic depiction of a network in which an electronic financial transaction may be placed, in accordance with the present disclosure;

FIG. 2 is a schematic block diagram of an automated document processing system according to an embodiment of the present disclosure;

FIG. 3A is a schematic side view of two overlapping checks passing through a path of travel past an optical multi-feed detection system according to an embodiment of the present disclosure;

FIG. 3B is a schematic top view of the system of FIG. 3A;

FIG. 4 illustrates an arrangement of the opto-electronic devices according a possible embodiment of the present invention;

FIG. 5 illustrates a general purpose computing system for use in implementing as one or more computing embodiments of the present disclosure;

FIG. 6 illustrates a flowchart of detection and voting process according to an example embodiment of the present disclosure;

FIG. 7 illustrates a flowchart of methods and systems for detecting multiple document feeds in an automated document processing system, according to an example embodiment of the present disclosure; and

FIG. 8 illustrates a user interface displaying detected document transmissivity at different light source intensities as evaluated by the systems of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In general, a multiple document feed detection system is disclosed. The multiple document feed detection system is disclosed as used in conjunction with an automated document processing system in a document processing network. The system includes opposing light sources and photodetectors across a path of travel of documents. The system further includes a signal detection and voting module interconnected with the light sources and the phototransistors to detect the presence of the overlapping documents passing though the path of travel.

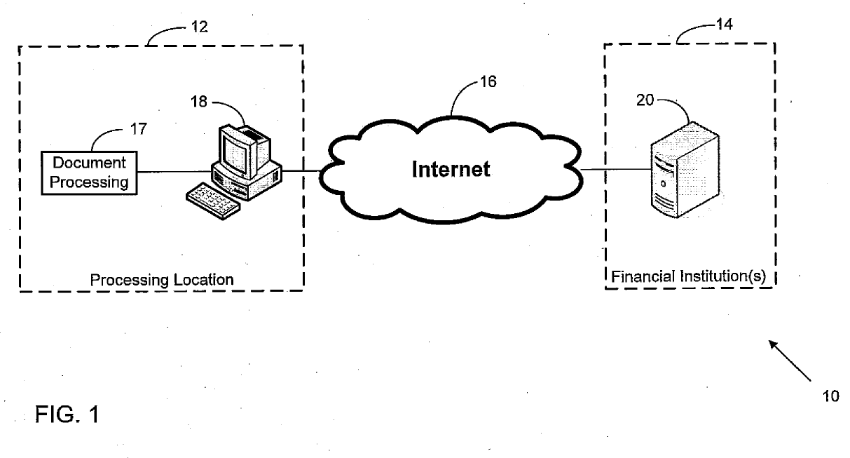

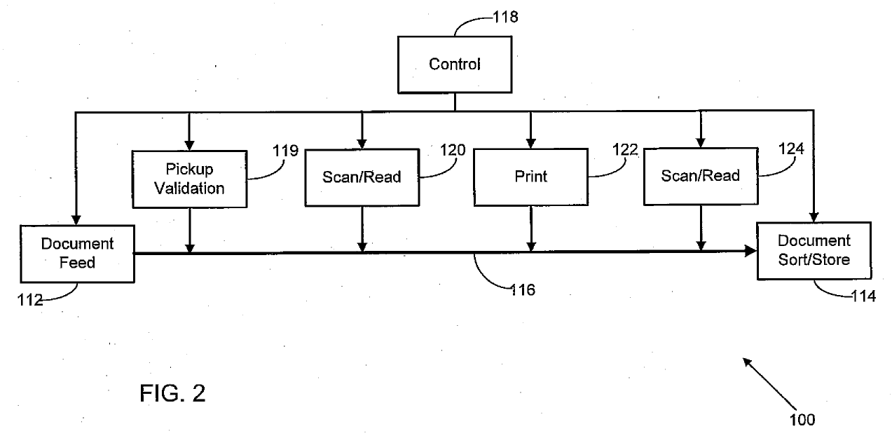

One specific example of a document processing network in which the systems and methods of the present disclosure may be used is shown in FIG. 1. FIG. 1 illustrates a schematic view of a network 10 in which a financial transaction may take place, according to a possible embodiment of the present disclosure. The network 10 generally includes one or more document processing locations 12 and financial institutions 14, communicatively connected by a network, shown as the internet 16. A document processing location 12 may be any of a number of places of business at which a financial transaction may take processed, such as a location of a purchase or sale of goods and services, or a financial institution. In certain embodiments of the present disclosure, the document processing location 12 is a bank that processes a large number of checks for payment. Each document processing location 12 includes a document processing system 17 interconnected with a computing system 18. The document processing system 17 is arranged to provide the transaction. location with the ability to electronically acquire information about a printed document, such as a check used for payment in exchange for goods and/or services. In certain embodiments, the document processing system 17 can include a check scanner and magnetic character reader, a printing device, and various sorting devices for capturing and/or printing information on one or both sides of a check. Example document processing systems useable in the network 10 are described below in conjunction with FIGS. 2-4.

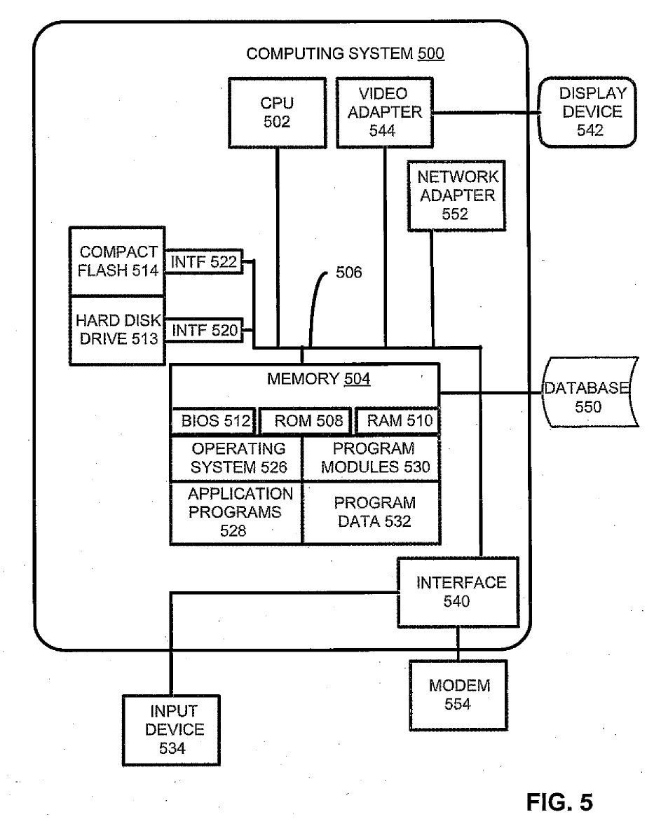

The computing system 18 can be any of a number of types of computing systems, such as a general purpose personal computer, or a specialized computer such as a cash register or inventory system. The computing system 18 can interconnect with the document processing system 17 by any of a number of standard or specialized communication interfaces, such as a USB, 802.11 a/b/g network, RF, infrared, serial, or other data connection. In certain embodiments, the computing system 18 runs an application configured to control the document processing system 17; in further embodiments, the computing system 18 receives data from the document scanner and stores and/or communicates the data (images, text, or other information) to other systems to which it is interconnected. An example of a computing system useable in the network 10 is described below in conjunction with FIG. 5.

Each of the financial institutions 14 generally includes a computing system 20, which is configured to receive electronic records of financial transactions relevant to the financial institutions. The computing system 20 can be any of a number of types of computing systems capable of storing and managing financial transactions; in the embodiment shown, the computing system is a server system comprising one or more discrete computing units interconnected, as is known in the art.

The electronic records can be electronic transaction records, and can include scanned copies of documents memorializing financial transactions. In a particular example, an electronic record can reflect a purchase made with a check, in which the electronic record includes the relevant information on the face of the check, the routing and institution number printed on the check, and an image of one or more sides of the check, used to validate the other information and to display relevant endorsements of the check. Other electronically captured transactions, such as credit card transactions, contracts, or other negotiable instrument transactions may be tracked using the network 10 as well.

The internet connection 16 depicted can be any of a number of WAN, LAN, or other packet based communication networks such that data can be shared among a number of computing systems or other networked devices. Furthermore, although in the embodiment shown two computing devices 18, 20 at different, specific locations are depicted, the computing devices and/or the document processing system 17 may be located at the same location or within the same network.

Referring now to FIG. 2, an automated document processing system 100 is shown within which aspects of the present disclosure may be implemented. The automated document processing system 100 provides an overview of the basic steps required to process documents, such as checks, in a high-volume system in which user supervision is minimized. The automated document processing system 100 can represent, for example, a possible embodiment of the document processing system 17 of FIG. 1.

In one embodiment, the automated document processing system 100 is a check processing system used to print and scan checks at a financial institution or document processing company. The automated document processing system 100 includes a document feeder 112 interconnected with a document sorter along a path of travel 116 of documents. The document feeder 112 is generally a document take-up mechanism provided with a large number of documents that are required to be processed. In a possible embodiment, the document feeder 112 receives 600 or more documents, such as checks, for processing. The document sorter 114 is an endpoint at which the documents have been processed, and can include one or more sorting mechanisms and/or document receiving apparatus configured to arrange physical documents in a desired manner. The document sorter 114 places processed documents into one or more pockets, each of the pockets holding a number of processed documents.

The path of travel 116 may be defined by any of a number of document movement and/or guiding mechanisms, such as rollers, guides or other systems able to grip and move documents from the document feeder 112 to the document sorter 114. A control system 118 is interconnected to the document feeder 112 and the document sorter 114 to control flow of documents along the path of travel 116. The control system 118 can be an application level program configured to control flow and processing of documents. The control system 118 can reside on a general purpose or specific purpose computing system capable of communicating with the document feeder 112 and document sorter 114.

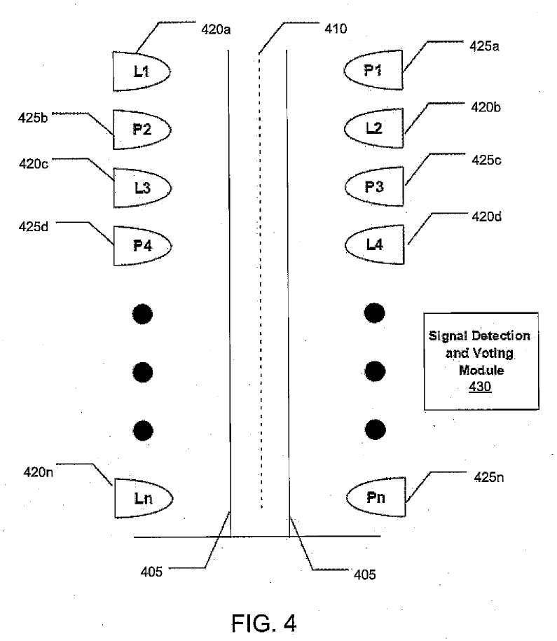

The control system 118 directs operation of a validation system 119. The validation system 119 validates the actions of the document feeder 112 to ensure that documents are fed into the path of travel 116 properly. The validation system 119 generally detects occurrences where multiple documents are taken up into the path of travel by the document feeder 112, and can comprise a number of configurations of opto-electronic components, such as light emitting diodes, phototransistors, or other devices, according to various embodiments of the present disclosure. Example validation systems 119, in conjunction with operations within a control system 118 and an interfaced computing system (such as the computing system 18 of FIG. 1) are described below in conjunction with FIG. 4.

The control system 118 further directs a scanning system 120 and a printing system 122. The scanning system 120 can scan one side of the documents passing along the path of travel 116, to store text and/or images displayed on the documents. The printing system 122 prints desired characters and/or images onto documents passing by the printing system along the path of travel 116. The printing system 122 can incorporate a print assembly which is configured to print from a stationary printing aperture onto moving documents passing by the printing system along the path of travel. In the example of a check processing system, the printing system 122 can print an endorsement onto the back of a check which is being processed at a financial institution operating the automated document processing system 100. Other documents may be processed as well, by financial institutions or other document processing entities.

Other functionalities may be incorporated along the path of travel 116, such as additional scanning, printing, or character reading systems. The existence of any of these additional systems is a matter of system configuration, depending upon the needs of the institution using the system.

By passing documents through the automated document processing system 100, a large volume of documents can be printed and electronically captured, such that various records can be stored for each of a large number of documents. In the case of a financial institution processing checks or other documents, that institution can endorse a large number of checks, can capture check images and routing information, and can appropriately sort the document for distribution back to the issuing institution of the check.

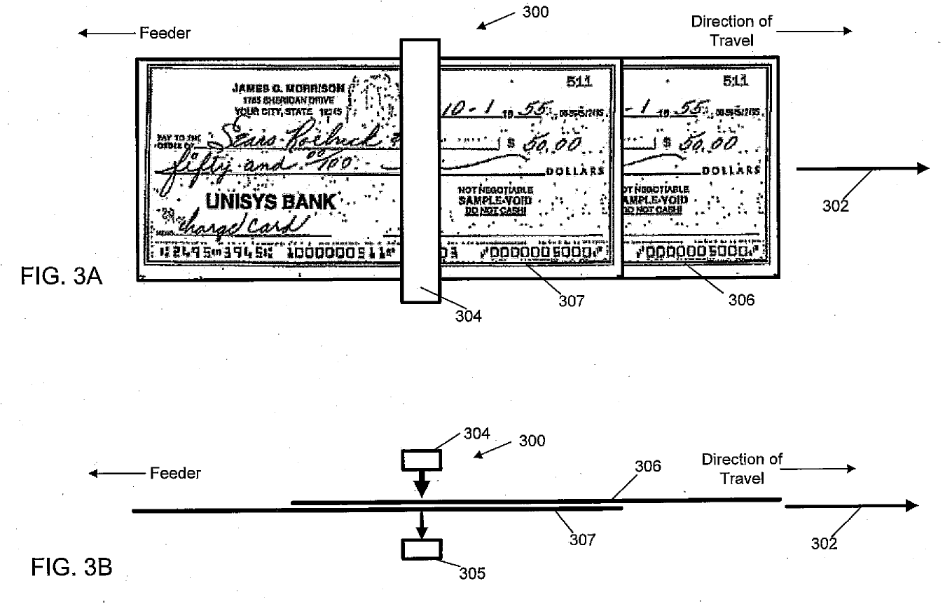

FIGS. 3A and 3B illustrate the orientation of an optical multi-feed detection system 300 useable in the automated document processing system 100 of FIG. 2. FIG. 3A shows a schematic side view of the multi-feed detection system 300, while FIG. 3B Illustrates a top view of the system. The system 300 is placed along a path of travel 302, preferably near to but downstream along the path of travel 302 from a document feeder.

In the embodiment shown, the system 300 extends the height of the tallest possible document passing through the automated document processing system to allow detection of overlapping documents at various document heights. In further embodiments beyond that shown, the system 300 only extends partially along the height of the various possible documents which may be accepted into the document processing system. The system 300 includes two opposed portions 304, 305 (seen in FIG. 3B) placed on opposing sides of the path of travel 302. In certain embodiments, each of the opposed portions 304, 305 of the system 300 includes a plurality of optoelectronic components, such as those shown and described in FIG. 4, below, allowing detection of the thickness of documents based on the optical transmissivity of those documents at a number of different-light intensities.

In the embodiment shown two overlapping checks 306, 307 are received into the path of travel 302 of a document processing system, such that the checks overlap (i.e. there is no space provided between the checks along the path of travel). In accordance with the system 300 as described, repeated optical transmissions of a variety of intensities are measured to determine a relative transmissivity at various portions along documents passing in front of the system 300. For example, in the system as shown, the relative optical transmissivity between the two portions 304, 305 will be highest when neither of the documents 306, 307 are between the portions and along the path of travel. When the first document 306 is between the portions 304, 305, the optical transmissivity will be generally lower than when no document resides between the portions, and will be generally constant. When both documents 306, 307 overlap in the region between the portions 304, 305, the optical transmissivity will be lower than when only one of those documents passes between the portions. The various opto-electronic components, as described below, can assist in detection of the instances in which documents overlap.

Although in the schematic system of FIG. 3B light is illustrated as unidirectional across the path of travel 302, in fact certain embodiments of the present disclosure orient opto-electronic components such that light is directed in both direction across the path of travel. Such embodiments may be desirable in order to reduce crosstalk or further isolate optoelectronic components, as described below. For this reason, FIG. 3B is intended as a simple schematic view of the operation of a portion of the multi-feed detection systems of the present disclosure.

FIG. 4 illustrates an arrangement 400 of opto-electronic devices according a possible embodiment of the present disclosure. The arrangement of devices shown can, in various embodiments, be incorporated into a multiple feed detection system of an automatic document processing system, as described above. The arrangement 400 of opto-electronic devices includes a set of light sources and corresponding photodetectors placed along the path of travel in a document processing system. In the embodiment shown, the light sources and photodetectors correspond to a plurality of LED/phototransistor pairs 420a/425a-420n/425n, respectively, placed along the track walls 405 of a path of travel 410 used by documents passing through the device. The LED/phototransistor pairs 420a/425a-420n/425n are arranged in alternating orientations across the path of travel 410 to reduce the impact of ambient light as the documents are processed. This alternating arrangement of LED/phototransistor pairs 420a/425a-420n/425n also reduces observed variance due to the proximity the detector devices from target documents. 5 The LED/phototransistor pairs 420a/425a-420n/425n of the present disclosure are, in certain embodiments, low cost devices that may be used in place of more expensive and more complicated vacuum, acoustic and friction alternate mechanisms of existing systems, and provide similar or better accuracy in detecting multi-feed errors. LED/phototransistor pairs 420a/425a-420n/425n may also be used to complement vacuum, acoustic and friction alternate mechanisms to increase accuracy in detecting multi-feed errors.

The present disclosure includes a signal detection and voting module 430 that receives and processes signals from the LED/phototransistor pairs 420a/425a-420n/425n to detect multi-feed errors—i.e. it is configured to detect the presence of overlapping documents passing through the path of travel 410. The signal detection and voting module 430 is interconnected with the light sources and the phototransistors and performs a voting process from among the detected results from the LED/phototransistor pairs 420a/425a-420n/425n. This process can be used to reduce noise in a generated signal from the LED/phototransistor pairs 420a/425a-420n/425n that may be caused by document design (i.e. document background images). This voting process weights the individual votes from the individual LED/phototransistor pairs 420a/425a-420n/425n based upon device position, a transfer function (IIn: IPn), and particular. LED settings used for a desired phototransistor response to improve detection rate and reduce false positive results.

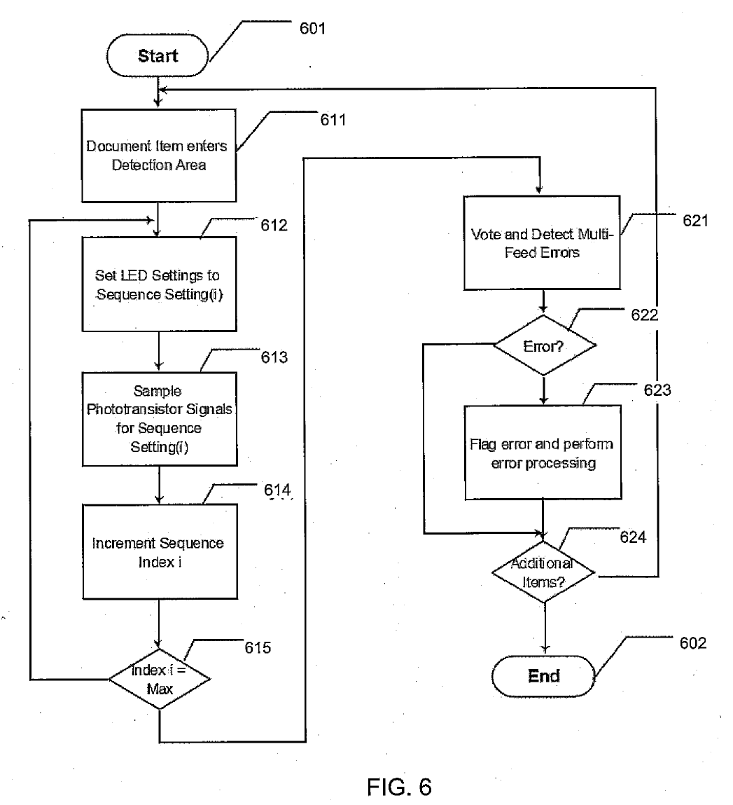

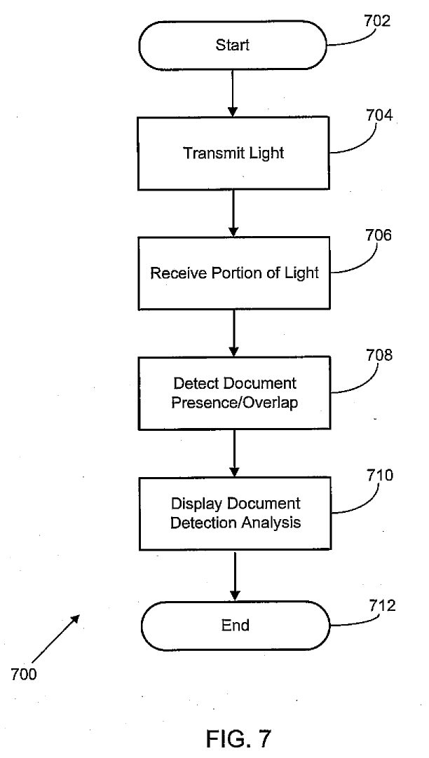

The module 430 can perform a variety of actions to monitor the documents passing through a document processing system. In one embodiment, the module 430 generates signals to activate the LEDs 420a-420n in a desired sequence. The module 430 receives the corresponding signals from the phototransistors 425a-425n and performs the voting process to detect multi-feed errors. The module may be implemented as a software implemented process executing on a programmable processing device. Signals from the phototransistors 425a-425n may be sampled to generate digitally encoded values used within the software process using a processing system as illustrated in FIG. 6. An example output of such a system is described below in conjunction with FIG. 7. In alternate embodiments, these signals may also be processed as analog signals using comparators and related devices to perform the detection and voting processing.

Heuristics from document history or other attributes, including thickness, homogeneous backgrounds, and the like, can be used to further tune detection accuracy by filtering document noise. Phototransistor response from varied LED intensity settings, with and without documents in the paper path, provide significant signals received by and generated by the phototransistor pairs to detect not only a presence of an item in the path of travel 410 in addition to the relative transmissivity of items in the path 410.

In certain embodiments, the signal detection and voting module 430 controls the output intensities of the LEDs 420a-420n, and directs the LEDs to illuminate at a variety of intensities. The varied LED settings, as directed by the signal detection and voting module 430, are determined based upon real-time response from phototransistors or are determined using predetermined system characteristics or system response ranges.

Detection methods used by the signal detection and voting module 430 are determined based upon overall detection time and ability to obtain adequate samples in a detection area between the LED/phototransistor pairs 420a/425a-420n/425n of the path of travel 410. The present disclosure contemplates use of an entire document length to determine the existence of a multi-feed error, by monitoring the document at a variety of discrete points as it passes by the LED/phototransistor pairs 420a/425a-420n/425n. In certain embodiments, the LED settings are varied by the signal detection and voting module 430 in a fixed, repeating sequence. Phototransistor responses are logged for each LED setting. Patterns in the phototransistor response signals are recognized across LED values, vertical sampling locations, and horizontal sampling locations to detect multi-feed errors and/or to rule out a multi-feed error. An example graph of such results and post-processing is shown and described below in FIG. 7.

Mapping special document transmissivity, with an allowance for environmental variance allows for discrete and accurate pattern recognition. These environmental variances may include ambient light, document proximity, and document background image generated noise.

Although the arrangement 400 and signal detection and voting module 430 are described in conjunction with particular operations which may be used to detect multiply-fed documents in a document processing system, it is understood that variations of these systems may be implemented as well. For example, more or fewer optoelectronic devices can be used in the arrangement than those shown; furthermore, other optical detectors or transmitters can be used beyond the LEDs and phototransmitters described herein. Furthermore, although a particular implementation of the signal detection and voting module 430 is described herein as directing operation and managing data acquisition from the opto-electronic components, in various other embodiments, the control aspects of the signal detection and voting module 430 are separated from and performed by different circuitry from the data acquisition and voting aspects of the module 430. In such embodiments, part or all of these aspects can be performed either within a document processing system, or on a computing system communicatively connected with a document processing system, such as the programmable processing system 500 of FIG. 5, below.

With reference to FIG. 5, an exemplary system for implementing the invention includes a programmable processing system 500, including a processor unit 502, a system memory 504, and a system bus 506 that couples various system components including the system memory 504 to the processor unit 500. The system bus 506 may be any of several types of bus structures including a memory bus or memory controller, a peripheral bus and a local bus using any of a variety of bus architectures. The system memory includes read only memory (ROM) 508 and random access memory (RAM) 510. A basic input/output system 512 (BIOS), which contains basic routines that help transfer information between elements within the processing system 500, is stored in ROM 508.

The processing system 500 further includes a hard disk drive 513 for reading from and writing to a hard disk, and a flash drive 514, which can be a compact flash drive of any of a number of formats. The hard disk drive 513 and flash drive 514 are connected to the system bus 506 by a hard disk drive interface 520 and a flash drive interface 522, respectively. The drives and their associated computer-readable media provide nonvolatile storage of computer readable instructions, data structures, programs, and other data for the processing system 500.

Although the exemplary environment described herein employs a hard disk and a flash drive 514, other types of computer-readable media capable of storing data can be used in the exemplary system. Examples of these other types of computer-readable mediums that can be used in the exemplary operating environment include magnetic cassettes, CD-ROM or DVD-ROMs, digital video disks, Bernoulli cartridges, random access memories (RAMs), and read only memories (ROMs).

A number of program modules may be stored on the hard disk, ROM 508 or RAM 510, including an operating system 526, one or more application programs 528, other program modules 530, and program data 532. A user may enter commands and information into the processing system 500 through an input device 534 such as a keyboard and mouse or other pointing device. Examples of other input devices may include a microphone, joystick, game pad, satellite dish, and scanner. These and other input devices are often connected to the processing unit 502 through a serial port interface 540 that is coupled to the system bus 506. Nevertheless, these input devices also may be connected by other interfaces, such as a parallel port, game port, or a universal serial bus (USB). A monitor 542 or other type of display device is also connected to the system bus 506 via an interface, such as a video adapter 544. In addition to the monitor 542, personal computers typically include other peripheral output devices (not shown), such as speakers and printers.

The processing system 500 may operate in a networked environment using logical connections to one or more remote computers. The remote computer may be another personal computer, a server, a router, a network PC, a peer device or other common network node, and typically includes many or all of the elements described above relative to the processing system 500. The network connections include a local area network (LAN) and a wide area network (WAN). Such networking environments are commonplace in offices, enterprise-wide computer networks, intranets, and the Internet. The computing system 500 can also interface with an external database 550, such as a data store resident on a separate computer or peripheral device.

When used in a LAN networking environment, the processing system 500 is connected to a local network through a network interface or adapter 552. When used in a WAN networking environment, the processing system 500 typically includes a modem 554 or other means for establishing communications over a wide area network, such as the Internet. The modem 554, which may be internal or external, is connected to the system bus 506 via the serial port interface 540. In a networked environment, program modules depicted relative to the processing system 500, or portions thereof, may be stored in the remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

FIG. 6 illustrates a flowchart of methods and systems 600 for detecting overlapping documents in a document processing system, according to an example embodiment of the present disclosure. The methods and systems of FIG. 6 can be used in conjunction with the optoelectronic components and computing system of FIGS. 4-5, respectively, to detect multiply fed documents (i.e. overlapping documents) passing through a path of travel of a document processing system, such as the systems described above. The system 600 begins 601 and a document item enters the detection area 611. While the document item is in the detection area, the LED settings for the LED/phototransistor pairs 420a/425a-420n/425n are varied in a fixed, repeating sequence. This sequence comprises setting the LED settings to a sequence setting(i) 612, sampling the corresponding phototransistor signals 613, and incrementing sequence index i 614. When test module 615 determines that the sequence index i equals a Max value, the sequence of signal generation and detection ends. While sequence index i is less than the Max value, the processing returns to setting the LED settings to a sequence setting(i) 612.

Once all of the sequence samples are generated, the voting and multi-feed error detection determination is made 621. If test module 622 determines if an error is present, the error is flagged and corresponding error processing occurs 623 before test module 624 determines if additional document items are present to be processed 625. Otherwise, processing proceeds directly to test module 624. If test module 624 detects additional document items are to be processed, the processing returns to a document item entering the detection area 611; otherwise the processing ends 602.

FIG. 7 illustrates a flowchart of methods and systems for detecting multiple document feeds in an automated document processing system, according to an example embodiment of the present disclosure. The system 700 generally corresponds to an example use of the methods and systems of FIGS. 4-6 to detect overlapping documents passing along a pat of travel in an automated document processing system. The system 700 is instantiated at a start operation 702, which corresponds to initial use of the automated document processing system in conjunction with a document, such as by initial take-up of a document by a document feeder and passing that document along a path of travel to a multi-feed detector, such as those described herein.

Operational flow proceeds to a transmission module 704. The transmission module corresponds to transmitting light from a plurality of light sources across a path of travel of documents in an automatic document processing system. In certain embodiments of the transmission module 704, aspects of the transmission module can be performed by software and electrical connections from a computing system to a plurality of opto-electronic components, such as light emitting diodes, within the document processing system.

Operational flow proceeds from the transmission module 704 to a receiving module 706. The receiving module 706 receives and measures light transmitted using the transmission module 704. The receiving module 706 operates using a number of photodetectors, such as phototransistors, which are located on the opposing side of the path of travel as the corresponding light sources utilized by the transmission module 704.

A detection module 708 detects the presence of overlapping documents passing along the path of travel based on the portion of the light received at the plurality 7 of photodetectors. The detection module 708 also can be configured to detect the presence/absence of a document in the path of travel. The detection module 708 performs a voting process based on the data obtained from the plurality of photodetectors, and uses In certain embodiments, the detection module 708 executes within a computing system interfaced with the document processing systems (e.g. those of FIGS. 1-2) described herein. In further embodiments, the detection module 708 may at least partially execute within the document processing system itself.

In certain further embodiments, the transmission module 704, receiving module 706, and detection module 708 operate at a plurality of different light intensities, wilt the detection module 708 using the data received at the variety of light intensities to conclude, based on results received from the receiving module 706, whether one or more documents are present in the path of travel.

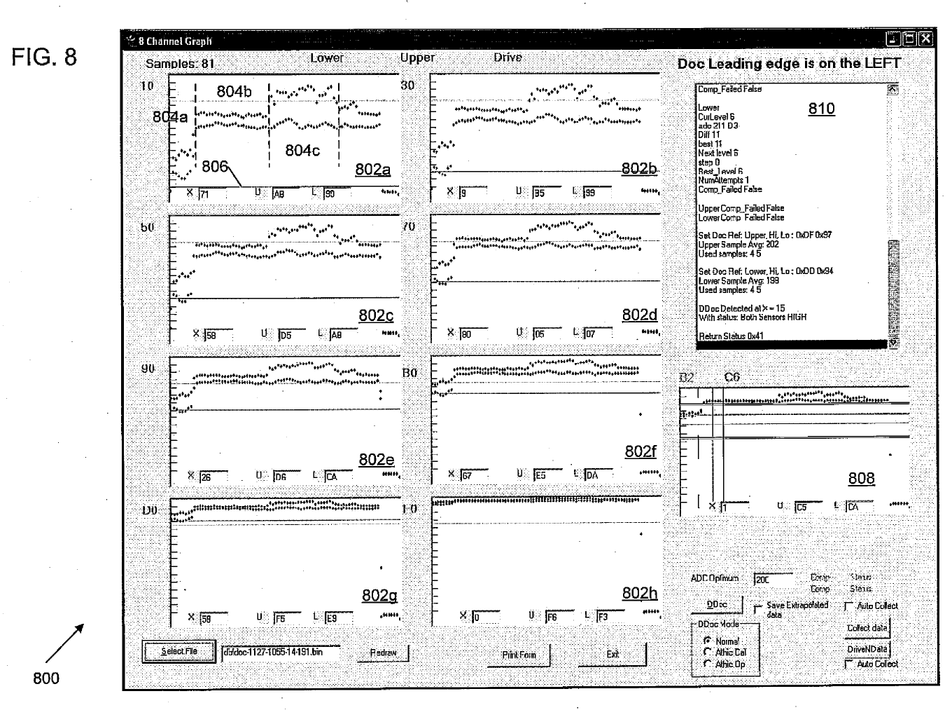

FIG. 8 illustrates a user interface 800 displaying detected document transmissivity at different light source intensities as evaluated by the systems of the present disclosure. The user interface 800 illustrates data collected using an optical multi-feed detection systems described in conjunction with the present disclosure. The user interface 800 includes a plurality of sub-regions 802a-h, each subregion containing a data plot illustrating the relative transmissivity of a document (or overlapping documents) when that document passes along a path of travel in a document processing system. Each of the sub-regions 802a-h is associated with a corresponding, increasing light intensity setting (designated by the labels 10, 30, 50, 70, 90, B0, D0, and F0, respectively, with the level of light intensity reflected in the horizontal line passing across each region), such that the eight regions correspond to repeated cycling through of eight light intensity settings over a given time. Each region 802a-h shows the upper and lower bounds of the relative losses in the transfer function between transmitting and detecting light, as reflected in the two sets of sample points plotted per region.

In the embodiment shown, the sub-regions 802a-h illustrate detection of a document and detection of overlapping documents using the systems and methods described above. For example, in region 802a, it can be seen that a first set of samples 804a have a low measure of relative loss, as measured by both of the photodetectors used in the system. After an initial low period, a second region 804b represents a single document passing along the path of travel such that a higher loss level is detected. However, both sets of data are below a determined threshold level 806, as determined by document history, heuristics, and other methods as described above, indicating that only a single document is passing through the document processing system. A third region 804c is reflected in the portion where one of the two sensors detects substantial loss in transmissivity. This corresponds to an overlap in documents, resulting from a multiple feed instance from a document feeder.

System recognition of this overlap region is obtained through use of the voting process described above in conjunction with the various regions 802a-h. Similar segmentation and analysis can be performed on the various other regions 802b-h, with similar regions being separated and analogous analysis performed. However, it is apparent in review of the various regions 802a-h that, based on the varying thickness of documents analyzed, different intensities of light from the LEDs may be optimal in detecting multiple document feeds. For example, in the example shown in FIG. 8, region 802a illustrates distinct levels of transmissivity, while region 802h illustrates little difference in transmissivity. For this reason, a composite region 808 compiles the various regions 802a-h, and a voting process can be performed on this composite region. Based on the voting process (as described above), the region 804c (as detected through detection of transmissivity relating to a range of LED settings reflected in regions 802a-h) is determined to correspond in an overlap in documents, and an alert signal can be generated to indicate to a user that such a condition took place.

Additionally, a data report region 810 displays results of the analysis of the document feed analysis. The data report region 810 includes a textual report reflecting the analysis performed to arrive at the graphical display regions 802a-h and composite region 808. The data report displayed in the data report region 810 can also be logged on the computing system performing the analysis (e.g. the computing system 500 of FIG. 5) and can be used in subsequent processing as historical multi-feed analysis data.

Although in the embodiment shown, the user interface 800 includes a variety of regions and data points within those regions, it is understood that the layout of the user interface may change based on user needs with respect to the analysis of multi-feed data. The specific regions and data points may also change based on the number, intensity, and type of opto-electronic devices used, the voting methodology adopted the sampling rate of the system as a whole, and other factors. Furthermore, the multi-feed detection system may use other methods of detecting and processing multi-feed occurrences other than the processing and display reflected in the user interface 800 in accordance with the previously described methods and systems.

The above specification, examples and data provide a complete description of the manufacture and use of the composition of the invention. Since many embodiments of the invention can be made without departing from the spirit and scope of the invention, the invention resides in the claims hereinafter appended.

1. A multiple document feed detection system comprising:
a plurality of light sources oriented to direct light across a path of travel of documents;
a plurality of photodetectors placed adjacent to the path of travel, each photodetector placed on an opposite side of the path of travel from a corresponding light source and oriented toward the corresponding light source, the plurality of photodetectors configured to detect transmissivity of light emitted from the light sources through documents passing through the path of travel; and
a signal detection and voting module interconnected with the light sources and the phototransistors, the signal detection and voting module configured to detect the presence of the overlapping documents passing through the path of travel.

2. The system of claim 1, wherein the signal detection and voting module resides in a personal computer communicatively connected to the automated document processing system.

3. The system of claim 1, wherein the signal detection and voting module controls operation of the light sources and photodetectors.

4. The system of claim 1, wherein the signal detection and voting module derives plurality of transfer functions, each transfer function corresponding to a photodetector and corresponding light source.

5. The system of claim 4, wherein the transfer function provides a measure of the transmissivity of the document passing through the path of travel between the light sources and photodetectors.

6. The system of claim 1, wherein the light sources and photodetectors are linearly positioned at a common distance from a document feeder.

7. The system of claim 1, wherein each of the light sources are positioned at a common distance from documents passing along a path of travel.

8. The system of claim 1, wherein each of the photodetectors are positioned at a common distance from documents passing along a path of travel.

9. The system of claim 1, wherein the plurality of photodetectors comprise phototransistors.

10. The system of claim 1, wherein the plurality of light sources comprise light emitting diodes.

11. An automated document processing system comprising:
a document feeder arranged to serially feed documents into a path of travel;
a plurality of light sources oriented to direct light across the path of travel;
a plurality of photodetectors placed adjacent to the path of travel, each photodetector placed on an opposite side of the path of travel from a corresponding light source and oriented toward the corresponding light source, the plurality of photodetectors configured to detect transmissivity of light emitted from the light sources through documents passing through the path of travel; and
a signal detection and voting module interconnected with the light sources and the phototransistors, the signal detection and voting module configured to detect the presence of the overlapping documents passing through the path of travel.

12. The system of claim 11, wherein the signal detection and voting module resides in a personal computer communicatively connected to the automated document processing system.

13. The system of claim 11, wherein the plurality of photodetectors comprise phototransistors.

14. The system of claim 11, wherein the plurality of light sources comprise light emitting diodes.

15. The system of claim 11, wherein the plurality of light sources are arranged with alternating orientations across the path of travel.

16. The system of claim 11, wherein the automated document processing system is a check processing system.

17. The system of claim 11, wherein the light sources and photodetectors are linearly positioned at a common distance from the document feeder.

18. A method of detecting multiple document feeds in an automated document processing system, the method comprising:
transmitting light from a plurality of light sources across a path of travel of documents;
receiving at least a portion of the light at a plurality of photodetectors, each photodetector located on the opposing side of the path of travel of documents from a corresponding light source from the plurality of light sources; and
detecting the presence of overlapping documents passing along the path of travel based on the portion of the light received at the plurality of photodetectors.

19. The method of claim 18, wherein transmitting light from the plurality of light sources comprises transmitting light at a plurality of different intensities.

20. The method of claim 18, further comprising comparing the light received at the plurality of photodetectors to detect the presence of overlapping documents.

21. The method of claim 18, flier comprising detecting the presence of at least one document passing along the path of travel.

22. The method of claim 18, wherein detecting the presence of overlapping documents comprises performing a voting process based on data computed by a signal detection and voting module relating to the portion of the light received at the photodetectors.
